(19) United States
(12) Patent Application Publication
(10) Pub. No.: US 2025/0196786 A1
(43) Pub. Date: Jun. 19, 2025

(54) VEHICLE NETWORK SYSTEM FOR CONTROLLING ECU STATUS THROUGH MACHINE GROUP SETTINGS

(71) Applicant: HYUNDAI AUTOEVER CORP., Seoul (KR)

(72) Inventors: Sung Jin Choi, Seoul (KR); Ye Ji Park, Seoul (KR); Dong Jae Won, Seoul (KR); Sang Won Kim, Seoul (KR)

(73) Assignee: HYUNDAI AUTOEVER CORP., Seoul (KR)

(21) Appl. No.: 18/975,088

(22) Filed: Dec. 10, 2024

(30) Foreign Application Priority Data
Dec. 13, 2023 (KR) 10-2023-0180382

(51) Int. Cl. B60R 16/023; B60R 21/01; B60W 10/06; B60W 10/10; B60W 10/18; B60W 10/20; B60W 10/22; B60W 10/30; B60W 30/09; B60W 60/00

(52) U.S. Cl. CPC B60R 16/0231; B60W 10/06; B60W 10/10; B60W 10/18; B60W 10/20; B60W 10/22; B60W 10/30; B60W 30/09; B60W 60/001; B60R 21/01

(57) ABSTRACT

A vehicle network system for controlling the statuses of electronic control units (ECUs) configured to control an operation of a vehicle includes a plurality of machine groups (MGs). The ECUs are classified into the plurality of MGs according to specific functions. One of the MGs includes a main electronic control unit (ECU) configured to control the status of each machine group (MG) in the vehicle network system.

### CROSS REFERENCE TO RELATED APPLICATION

This application claims the benefit of and priority to Korea Patent Application No. 10-2023-0180382, filed on Dec. 13, 2023, the entire disclosure of which is hereby incorporated herein by reference.

### TECHNICAL FIELD

The present disclosure relates to a vehicle network system capable of efficiently controlling electronic control unit (ECU) status by setting up electronic control units (ECUs) configured to perform a specific function in an electronic network of a vehicle as a machine group.

### BACKGROUND

With the recent development of various functions of vehicles, electronic control units (ECUs) capable of performing these functions are having a high share in technological development.

In this regard, there is no way that a single electronic control unit (ECU) can handle all operations on functions that require high precision computations such as autonomous driving, and multiple ECUs need to form a network within a vehicle and perform their own roles.

Hence, according to a conventional vehicle network system, it has become difficult for a single ECU to handle all operations on functions that require high precision computations. Accordingly, a number of ECUs are configured to form a network in a vehicle and be responsible for specific functions or systems individually. However, such a distributed system has various problems.

First, a distributed vehicle network system can cause communication delay between the ECUs. In particular, functions that require high precision computations often call for fast response, and a distributed structure may have a delay in communication between each ECU. Because of this, there is a concern that performance deterioration may occur to the functions for which real-time response is crucial, as in autonomous driving and safety systems.

Moreover, it may be difficult to efficiently manage software responsible for each function. A number of ECUs need to cooperate while running their own software, and this may lead to problems in software version control, upgrade, compatibility, etc. When a new function or an update is required, it should apply to each ECU, and this makes management and maintenance and repair complicated.

Furthermore, a distributed network system structure requires a complex process, such as issuing an instruction to each ECU and synchronizing their status. Due to this, a delay may occur until a particular operation is performed, and this may degrade the performance and efficiency of the vehicle.

Additionally, a distributed vehicle network system may have more security vulnerabilities with increasing communication between ECUs. Thus, vehicle network systems according to the conventional art may be left vulnerable to hacking, malicious attacks, and so on, and this may bring vehicle system safety issues into greater prominence.

The subject matter described in this background section is intended to promote an understanding of the background of the disclosure and thus may include subject matter that is not already known to those of ordinary skill in the art.

### SUMMARY

An aspect of the present disclosure aims to provide a vehicle network system capable of controlling electronic control units (ECUs) collectively by classifying the ECUs into particular machine groups (MGs) according to functions.

Furthermore, another aspect of the present disclosure aims to provide a vehicle network system that newly defines an operation mode of an execution management (EM) in an electronic control unit (ECU) and operates in conjunction with a communication management (CM) module.

Furthermore, yet another aspect of the present disclosure is to provide a vehicle network communication method and a vehicle network apparatus that control ECU status through machine group (MG) settings.

An embodiment of the present disclosure provides a vehicle network system for controlling statuses of ECUs configured to control an operation of a vehicle. The vehicle network system includes a plurality of MGs. The ECUs are classified into the plurality of MGs according to specific functions. One of the MGs includes a main ECU configured to control the status of each MG in the vehicle network system.

The ECUs may communicate with one another by using at least one communication protocol of Controller Area Network (CAN), Local Interconnect Network (LIN), FlexRay, Ethernet, or Media Oriented Systems Transport (MOST).

The ECUs may include at least one of an engine control unit, a brake control module, a steering control module, an airbag control module, an electronic control suspension, a transmission control module, an infotainment and information control unit, an advanced driver assistance systems control module, a collision avoidance and prevention systems control module, or an autonomous driving control module.

A status of each sub-ECU included in an MG having a status controlled by a signal transmitted from the main ECU may be controlled by the signal.

The ECUs may include an application layer including a plurality of application software programs, a hardware layer including hardware components, and an adaptive platform layer for interaction between the application layer and the hardware layer.

The application layer may include a plurality of functional groups (FGs). The plurality of application software programs is classified into the plurality of FGs according to specific functions.

The hardware layer may include an Ethernet port for network communication of the ECU.

The adaptive platform layer may include an EM configured to manage execution and termination of application software programs that run in the ECU and may include a CM configured to support data communication between the ECUs in the vehicle network system.

An operation mode of the EM may include a primary mode configured to control the status of each MG in the vehicle network system; or a secondary mode configured to operate the EM (EM_S) of each sub-ECU included in an MG having a status controlled by a signal transmitted from the main ECU including an EM (EM_P) operating in the primary mode.

There may be only one EM (EM_P) present within the vehicle network system that operates in the primary mode.

Another embodiment of the present disclosure provides a vehicle network communication method, which controls statuses of ECUs configured to control an operation of a vehicle. The vehicle network communication method includes, in an event occurrence determination step, determining whether or not a specific event has occurred. The method also includes, in an MG classification step, classifying the ECUs into a first MG, which is needed to perform a specific event, and a second MG, which is not needed to perform the specific event. The method also includes, in an MG control step, transmitting a signal to the first MG and the second MG through a main ECU. The method also includes, in a restoration step, restoring the ECUs are restored to an original state after the specific event is over. The ECUs configured to control the operation of the vehicle are classified into a plurality of MGs according to specific functions.

The method also includes controlling a status of each sub-ECU included in an MG by a signal. A status of the MG is controlled by the signal transmitted from the main ECU.

The method also includes managing, by an EM of an adaptive platform layer of the ECUs, execution and termination of application software programs that run in the ECU. The method also includes supporting, by a CM of the adaptive platform layer of the ECUs, data communication between the ECUs in a vehicle network system.

The method also includes, in a primary mode of the EM, controlling the status of each MG in a vehicle network system; or in a secondary mode of the EM, operating the EM (EM_S) of each sub-ECU included in an MG having a status controlled by a signal transmitted from the main ECU including an EM (EM_P) operating in the primary mode.

The MG control step may include, in a signal transmission step, transmitting, by the EM (EM_P) operating in the primary mode in the main ECU, a signal to the first MG and the second MG through the CM. The MG control step may include, in a signal reception step, receiving, by the sub-ECUs included in the first MG and the second MG, the signal. The MG control step may include, in an ECU status control step, controlling, by the EMs (EM_Ss) operating in the secondary mode in the sub-ECUs and having received the signal, the status of the corresponding ECU.

The restoration step may include, in an event termination determination step, determining whether or not the specific event is over. The restoration step may include, in a signal transmission step, transmitting, by the EM (EM_P) operating in the primary mode in the main ECU, a signal to the first MG and the second MG through the CM. The restoration step may include, in a signal reception step, receiving, by the sub-ECUs included in the first MG and the second MG, the signal. The restoration step may include, in an ECU status control step, controlling, by the EMs (EM_Ss) operating in the secondary mode in the sub-ECUs and having received the signal, the status of the corresponding ECU.

The restoration step may further include, after an event termination determination step, in a reporting step, reporting, by the EMs (EM_Ss) operating in the secondary mode in the sub-ECUs, to the EM (EM_P) operating in the primary mode about whether or not the event is over, so that the EM (EM_P) operating in the primary mode in the main ECU checks to see whether or not the event is over.

Yet another embodiment of the present disclosure provides a computer-readable storage medium having a program recorded thereon to perform a vehicle network communication method.

A further embodiment of the present disclosure provides a vehicle network apparatus for controlling statuses of ECUs configured to control an operation of a vehicle. The vehicle network apparatus includes a plurality of MGs. The ECUs are classified into the plurality of MGs according to specific functions. One of the MGs includes a main ECU configured to control the status of each MG in the vehicle network apparatus. A status of each sub-ECU included in an MG having a status controlled by a signal transmitted from the main ECU is controlled by the signal. An adaptive platform layer included in the ECUs includes an EM configured to manage execution and termination of application software programs that run in the ECU; and a CM configured to support data communication between the ECUs in the vehicle network apparatus.

An operation mode of the EM may include a primary mode configured to control the status of each MG in the vehicle network apparatus; or a secondary mode configured to operate the EM (EM_S) of each sub-ECU included in an MG having a status controlled by a signal transmitted from the main ECU including an EM (EM_P) operating in the primary mode.

As explained above, according to an embodiment of the present disclosure, there is provided a vehicle network system capable of controlling ECUs collectively by classifying the ECUs into particular MGs according to functions.

Furthermore, according to another embodiment of the present disclosure, there is provided a vehicle network system that newly defines an operation mode of an EM in an ECU and operates in conjunction with a CM module.

Furthermore, according to yet another embodiment of the present disclosure, there is provided a vehicle network communication method and a vehicle network apparatus that control ECU status through MG settings.

Technical aspects to be accomplished by the disclosure are not limited to the above-mentioned technical aspects, and other technical aspects not mentioned herein should be clearly understood from the following descriptions by those having ordinary skill in the art to which the present disclosure pertains.

### BRIEF DESCRIPTION OF THE DRAWINGS

FIG. 1 is a view showing a vehicle network system according to an embodiment.

FIG. 2 is a pattern diagram showing an electronic control unit (ECU) according to an embodiment.

FIG. 3 is a view showing a vehicle network system in which a plurality of electronic control units (ECUs) is interconnected and operates according to operation modes of execution managements (EMs).

FIG. 4 is a flowchart showing a vehicle network communication method according to an embodiment of the present disclosure.

FIG. 5 is a flowchart showing a machine group (MG) control step according to an embodiment of the present disclosure.

FIGS. 6 and 7 are flowcharts showing a restoration step according to an embodiment of the present disclosure.

### DETAILED DESCRIPTION

Hereinafter, embodiments of the present disclosure are described in detail with reference to the accompanying drawings. With regard to the reference numerals of the components of the respective drawings, it should be noted that the same reference numerals are assigned to the same or equivalent components even when the components are shown in different drawings. In addition, in describing the present disclosure, detailed descriptions of well-known configurations or functions have been omitted in order not to obscure the gist of the present disclosure.

In addition, terms, such as “first”, “second”, “A”, “B”, “(a)”, “(b)”, or the like, may be used in describing the components of the present disclosure. These terms are intended only for distinguishing a corresponding component from other components, and the nature, order, or sequence of the corresponding component is not limited to the terms. In the case where a component is described as being “coupled”, “combined”, or “connected” to another component, it should be understood that the corresponding component may be directly coupled or connected to another component or that the corresponding component may also be “coupled”, “combined”, or “connected” to the component via another component provided therebetween. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

In an embodiment, a vehicle network system for controlling the statuses of electronic control units (ECUs) configured to control the operation of a vehicle includes a plurality of machine groups (MGs). The ECUs are classified into the plurality of MGs according to specific functions. One of the MGs includes a main electronic control unit (ECU) capable of controlling the status of each machine group (MG) in the vehicle network system.

An ECU used in a vehicle is one of the key components in a car and efficiently controls and regulates various functions of the vehicle. The ECU monitors numerous systems and parts of the vehicle and quickly responds accordingly to maximize driving efficiency. The ECU is able to take measures to comply with environmental restrictions and improve air-fuel ratio.

One of the major functions of ECUs is engine control. An engine control ECU is able to maintain optimum air-fuel ratio and performance by monitoring the status of the engine in real time and adjusting the amount of fuel to be injected, the air flow, the valve timing, and so on. This may contribute to efficient fuel consumption and minimum exhaust gas emissions by the vehicle.

Besides, ECUs are able to manage the vehicle's safety system. Safety functions, such as brake control, airbag system, and safety belt detection, are quickly responded to and adjusted through an ECU. This plays an important role in preventing accidents and maintaining safety in the event of a collision.

The driving performance of the vehicle also can be enhanced by an ECU. The ECU may employ a variety of sensors and algorithms in order to offer optimum performance according to various driving conditions, such as traction control system, safety control, and passenger and cargo weight distribution. Consequently, the driver is able to drive in a stable and predictable way under various road situations.

Furthermore, ECUs may control the vehicle's convenience systems. For example, a smart key system, an automatic air conditioner, and an entertainment system, etc. all operate efficiently through ECUs and can increase the convenience of driver and passengers.

Meanwhile, cutting-edge technologies, such as artificial intelligence and machine learning, may be integrated into an ECU. The ECU allows for learning while the vehicle is driving, and the ECU also enables automatic application of an optimal condition. Moreover, information exchange and cooperation between vehicles can be achieved through vehicle-to-everything (V2X) technology for communication between vehicles.

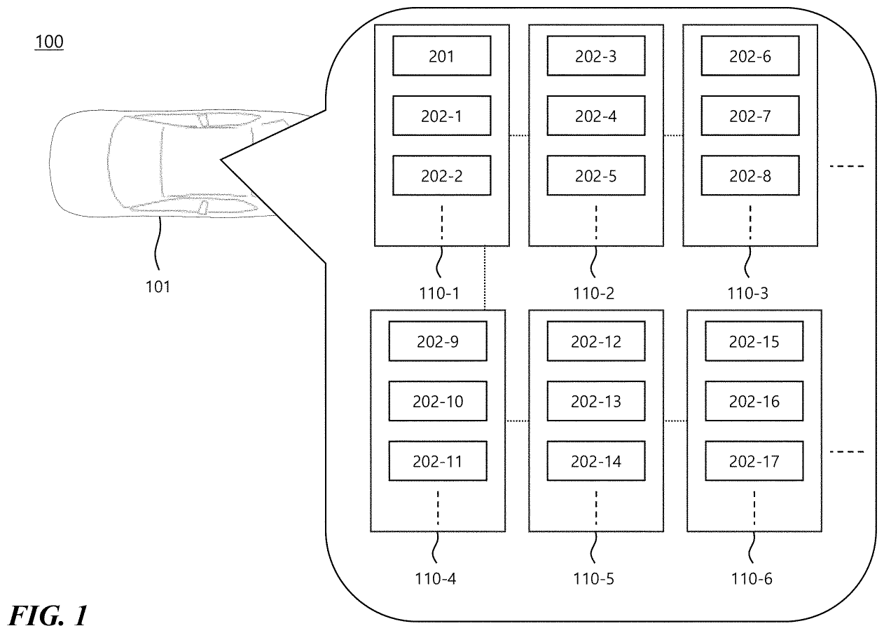

FIG. 1 is a view showing a vehicle network system according to an embodiment.

Referring to FIG. 1, a vehicle network system 100 according to an embodiment may include ECUs for controlling the operation of a vehicle 101.

Specifically, the vehicle network system 100 may include a plurality of MGs 110 (including 110-1, 110-2, 110-3, 110-4, 110-5, and 110-6) into which the ECUs for controlling the operation of the vehicle 101 are classified. Here, one of the MGs 110 may include a main ECU 201 capable of controlling the status of each MG 110 in the vehicle network system 100.

For example, the vehicle network system 100 may include a plurality of MGs 110-1, 110-2, 110-3, 110-4, 110-5, and 110-6 into which ECUs with various functions for performing operations of the vehicle 101 are classified according to specific functions. The vehicle network system 100 may include an MG 110-1, which includes a main ECU 201 capable of controlling these MGs 110-1, 110-2, 110-3, 110-4, 110-5, and 110-6. However, FIG. 1 is merely an example, and the number of MGs or the number of ECUs is not limited to what is shown in FIG. 1. Instead, the number of MGs or the number of ECUs may vary as needed.

The ECUs may communicate with one another by using at least one communication protocol selected from the group consisting of Controller Area Network (CAN), Local Interconnect Network (LIN), FlexRay, Ethernet, and Media Oriented Systems Transport (MOST).

The CAN communication protocol is a multi-master communication protocol used mainly for real-time communication. The CAN communication protocol may be equipped with an error recovery function that allows the entire system to operate even when a transmission line or bus collapses.

The CAN communication protocol is capable of high-speed data transmission and works usually in the range of 125 kbps to 1 Mbps.

The CAN communication protocol may be used mainly for engine control, transmission control, brake systems, airbags, safety systems, etc.

The LIN communication protocol is a single-master communication protocol for low-speed communication and may be used mainly for simple communication between devices. Thus, the LIN communication protocol serve as a cheap and cost-efficient solution that performs simple functions of cars.

The LIN communication protocol may be used for in-vehicle low-level functions and basic communication, for example, window lift, steering wheel control, etc.

The FlexRay communication protocol is a protocol that provides high bandwidth and stability and may be used mainly for advanced driver-assistance systems and real-time systems.

The FlexRay communication protocol may support simultaneity and timing synchronization, which enables flexible communication.

Accordingly, the FlexRay communication protocol may be used mainly for brake and steering control, advanced driver-assistance systems, real-time applications, etc.

The Ethernet communication protocol provides high bandwidth and high speeds and may be used for advanced driver-assistance systems and mass data transfer. The Ethernet communication protocol allows for communications between various types of devices by using a standard network protocol compatible with the internet.

Therefore, the Ethernet communication protocol may be used mainly for ADAS, camera and sensor data transmission, infotainment systems, etc.

The MOST communication protocol is specialized to transport multimedia data through optical communication.

The MOST communication protocol may provide high bandwidth to process high-quality audio and video data.

Therefore, the MOST communication protocol may be used mainly for multimedia applications, such as in-vehicle audio systems and video entertainment systems.

The ECUs may include at least one of an engine control unit, a brake control module, a steering control module, an airbag control module, an electronic control suspension, a transmission control module, an infotainment and information control unit, an advanced driver assistance systems control module, a collision avoidance and prevention systems control module, or an autonomous driving control module.

An engine control unit may intelligently control the operation of the engine. Specifically, the engine control unit may provide optimal air-fuel ratio and performance by precisely managing fuel injection, carburetion, valve timing, and exhaust systems. Such an engine control unit may dynamically adjust the operating condition of the engine by analyzing sensor data.

The brake control module may optimize the brake system of the vehicle and provide safe braking. Such a brake control module aims to prevent slippage and improve driving safety by managing an anti-lock brake system (ABS) and a traction control system (TCS).

The steering control module may intelligently control the steering system to maintain driving safety. Such a steering control module aims to provide the driver comfortable and swift handling through an electronic power steering function.

The airbag control module may perform a function of protecting a driver and passengers by causing airbags to inflate during a vehicle collision. Such an airbag control module by activate the airbags at the right time by analyzing collision sensor data.

The electronic control suspension may perform a function of automatically controlling the suspension system of the vehicle to maintain driving stability and comfort in a balanced way. Such an electronic control suspension aims to provide optimal driving by dynamically controlling the suspension based on vehicle status and driving conditions.

The transmission control module may perform a function of optimizing an automatic or manual transmission to improve fuel efficiency and optimize performance. Such a transmission control module enables smooth and efficient driving by precisely controlling gear change timings.

The infotainment and information control unit may manage an in-vehicle entertainment system and an information display. Such an infotainment and information control unit may provide convenience to a driver and passengers by integrating Bluetooth connection, navigation, media player, etc.

The advanced driver assistance systems control module may perform a function of effectively managing driving assistance systems, such as lane keeping assistance, automatic emergency braking, parking assistance, etc. Such an advanced driver assistance systems control module aims to provide the driver with additional safety functions based on sensor data.

The collision avoidance and prevention systems control module may intelligently manage safety systems, such as forward collision warning, automatic emergency braking, etc. Such a collision avoidance and prevention systems control module may recognize the surroundings through sensors and cameras and may prevent or mitigate a collision.

The autonomous driving control module may perform a function of effectively controlling autonomous driving functionality by using sensor data from radar, cameras, etc. Such an autonomous driving control module may make necessary driving decisions during driving.

Meanwhile, one of the plurality of MGs 110 includes a main ECU 201 capable of controlling the status of each MG 110 in the vehicle network system 100. The status of each sub-ECU 202 (including 202-1, 202-2, 202-3, 202-4, 202-5, 202-6, 202-7, 202-8, 202-9, 202-10, 202-11, 202-12, 202-13, 202-14, 202-15, 202-16, and 202-17) included in an MG 110 whose status is controlled by a signal transmitted from the main ECU 201 may be controlled by the signal transmitted from the main ECU 201.

For example, ECUs with various functions for performing operations of the vehicle 101 may include a plurality of MGs 110-1, 110-2, 110-3, 110-4, 110-5, and 110-6, which are classified according to specific functions. The vehicle network system 100 may include an MG 110-1, which includes a main ECU 201 capable of controlling the statuses of the MGs 110-1, 110-2, 110-3, 110-4, 110-5, and 110-6.

Moreover, the status of each sub-ECU 202-1, 202-2, 202-3, 202-4, 202-5, 202-6, 202-7, 202-8, 202-9, 202-10, 202-11, 202-12, 202-13, 202-14, 202-15, 202-16, and 202-17 included in the MGs 110-1, 110-2, 110-3, 110-4, 110-5, and 110-6 whose statuses are controlled by a signal transmitted from the main ECU 201 may be controlled by the signal transmitted from the main ECU 201.

However, FIG. 1 is merely an example, and the number of MGs or the number of ECUs is not limited to what is shown in FIG. 1. Instead, the number of MGs or the number of ECUs may vary as needed.

The ECUs may include an application layer including a plurality of application software programs, a hardware layer including hardware components, and an adaptive platform layer for interaction between the application layer and the hardware layer.

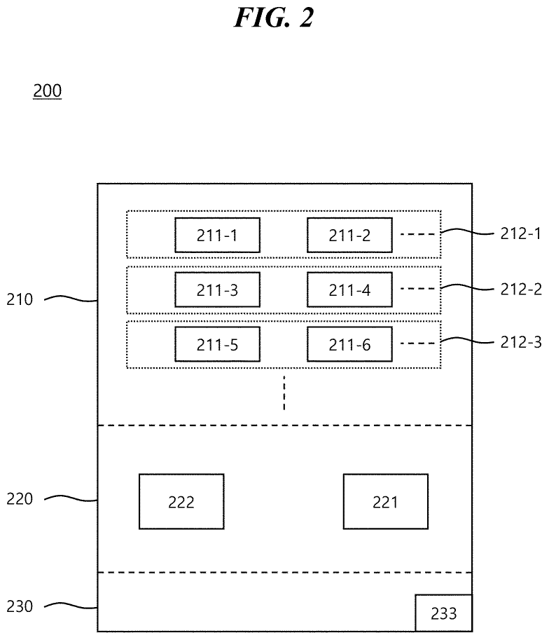

FIG. 2 is a pattern diagram showing an ECU according to an embodiment.

Referring to FIG. 2, an ECU 200 according to an embodiment of the present disclosure may include an application layer 210, an adaptive platform layer 220, and a hardware layer 230.

The application layer 210 may include application software programs 211 (including application software programs 211-1, 211-2, 211-3, 211-4, 211-5, and 211-6), the hardware layer 230 may include key hardware components required for the operation of the ECU 200, and the adaptive platform layer 220 may include a platform required for interaction between the application layer 210 and the hardware layer 230.

ECUs used in a vehicle network system are key components that control and manage various functions of the vehicle in an integrated manner.

These various functions of the vehicle may be implemented through application software programs 211 that run at the application layer 210. For example, these functions may include such functions as driving safety system, vehicle information and related entertainment, communication system, etc. The application software programs 211 included in the application layer 210 may decide related tasks for performing various functions of the vehicle and accordingly may control the operation of the vehicle by communicating with the hardware layer 230.

The hardware layer 230 may be responsible for physical components of the ECU 200. For example, the hardware layer 230 may include sensors, actuators, processors, memory, communication ports, etc. The hardware layer 230 may actually perform tasks decided at the application layer 210 and may collect data from a sensor or affect the outside through an actuator. Meanwhile, the hardware layer 230 may ensure flexibility and interoperability by providing a standardized interface and hardware abstraction.

The adaptive platform layer 220 is a component for supporting advanced functions for interaction between the application layer 210 and the hardware layer 230. Such an adaptive platform layer 220 may provide a dynamic software architecture and support functions that can be updated at runtime. Also, the adaptive platform layer 220 may perform a function for integrating new technologies applied to vehicles, such as autonomous driving, and may provide the flexibility to upgrade and alter the system during vehicle driving.

The application layer 210 according to an embodiment of the present disclosure may include a plurality of functional groups (FGs) 212 into which the plurality of application software programs 211 is classified according to specific functions. Because a plurality of application programs that can be executed in a single ECU 200 is classified and managed according to specific functions, the application software programs 211 may be operated promptly and efficiently.

For example, a plurality of application software programs 211-1, 211-2, 211-3, 211-4, 211-5, and 211-6 may be classified into FGs 212-1, 212-2, and 212-3 according to functions. However, FIG. 2 is merely an example, and the number of application software programs or the number of FGs is not limited to what is shown in FIG. 2. Instead, the number of application software programs or the number of FGs may vary as needed.

The hardware layer 230 according to an embodiment of the present disclosure may include an Ethernet port 233 for network communication of the ECU 200.

The Ethernet port 233 included in the ECU 200 is one of the devices that play an important role in a car's electronic system. Essentially, Ethernet may be used as a standard network protocol for communication between various electronic control units within a vehicle. The Ethernet port 233, integrated into the ECU 200, may facilitate data exchange between various functions of the vehicle and the system and provide enhanced performance and efficiency.

The Ethernet port 233 is usually located in key electronic control units within the vehicle and is responsible for communication between various systems and sub-systems of the vehicle. Here, Ethernet supports high bandwidth and is capable of fast data transfer and thus improves the real-time responsivity and performance of the vehicle. Also, Ethernet may ensure interoperability between devices from various manufacturers because it uses a standardized protocol.

An ECU that uses Ethernet may efficiently process various data generated in the vehicle and may control various functions such as driving safety system, information entertainment system, and vehicle diagnostics and maintenance and repair systems, and so on in an integrated manner. Also, vehicle manufacturers may perform software updates and upgrades through Ethernet in order to introduce latest technologies and enhanced functionality.

The Ethernet port 233 may provide the driver with better control and convenience by efficiently managing and integrating complex electronic systems of a vehicle. For example, an advance driver assistance system (ADAS) enables prompt and accurate decision-making by transmitting information collected through various sensors and cameras to a central processing unit via high-speed Ethernet communication.

Moreover, Ethernet may be suitable to process and transmit large amounts of data generated in the vehicle. Particularly, in the case of autonomous driving cars for which fast response between sensor and actuator is essential, the Ethernet port 233 may act as an important component even in the vehicle's autonomous driving system and may promptly process data collected from various sensors and cameras so as to understand and cope with the driving environment in real time.

In other words, the Ethernet port 233 included in the hardware layer 230 of the ECU 200 in the vehicle network enables efficient communication between various electronic systems of the vehicle and provides high bandwidth and fast data transfer. Thus, the driver may be provided with both safety and convenience.

The adaptive platform layer 220 according to an embodiment may include an execution management (EM) 222, which manages the execution and termination of application software programs 211 that run in the ECU 200, and may include a communication management (CM) 221, which supports data communication between the ECUs 200 in the vehicle network.

Specifically, the EM 222 may serve to manage and execute various control functions of a car. The EM 222 may coordinate integration between various systems and hardware in the vehicle in terms of software and may, in particular, provide real-time performance and safety. The EM 222 may improve the safety and performance of vehicle operation by efficiently managing algorithms that are executed in various parts, such as engine control, brake system, electric motor technology, safety functions, etc. Consequently, it is possible to make prompt responses and adjustments to cope with various conditions and situations that occur during driving.

Moreover, the CM 221 may serve to manage communication between various controllers and sensors in the vehicle. Various systems in the vehicle need to be efficiently operated through data exchange and interaction. The CM 221 aims to smoothly coordinate such communication to ensure prompt and stable transmission of data and accurately deliver information generated in real time during driving. Consequently, it is possible to optimize interoperability between systems in the vehicle and accurately deliver information necessary for the driver.

Meanwhile, the EM 222 and the CM 221 may work closely with each other to thereby optimize the overall performance of the vehicle. The EM 222 may provide efficient operation through execution of various algorithms and may allow resultant data to be shared with other systems through the CM 221. Consequently, the vehicle 101 is capable of self-optimized operation, such as monitoring current status during driving and taking necessary actions.

An operation mode of the EM 222 may include a primary mode for controlling the status of each MG 110 in the vehicle network system 100 or a secondary mode for operating the EM (EM_S) of each sub-ECU 202 included in an MG 110 whose status is controlled by a signal transmitted from the main ECU 201 including an EM (EM_P), which operates in the primary mode.

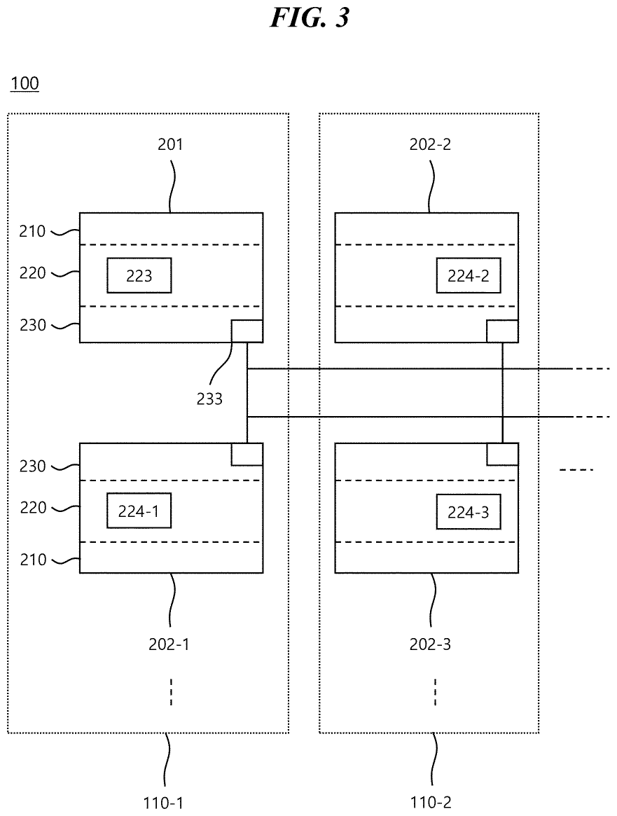

FIG. 3 is a view showing a vehicle network system in which a plurality of ECUs is interconnected and operate according to operation modes of EMs.

Referring to FIG. 3, a plurality of ECUs 201, 202-1, 202-2, and 202-3 may be interconnected and communicate through an Ethernet port 233. Here, the ECUs 201, 202-1, 202-2, and 202-3 may be classified into a plurality of MGs 110-1 and 110-2 according to specific functions.

Meanwhile, the EMs 222 included in the adaptive platform layers 220 of the ECUs 200 may include an EM_P 223 which operates in a primary mode for controlling the status of each MG 110 in the vehicle network system 100, and EM_Ss 224-1, 224-2, and 224-3, which operate in a secondary mode for operating the EMs 222 of all sub-ECUs 201-1, 202-3, and 202-3 included in the MGs 110-1 and 110-2 whose statuses are controlled by a signal transmitted from the main ECU 201 including the EM_P 223.

However, FIG. 3 is merely an example, and the number of MGs, the number of ECUs, the number of EMs, or the number of Ethernet ports is not limited to what is shown in FIG. 3. Instead, the number of MGs, the number of ECUs, the number of EMs, or the number of Ethernet ports may vary as needed.

Here, there is only one EM_P 223 present within the vehicle network system 100 that operates in the primary mode. Consequently, the MGs 100 may be controlled collectively to provide prompt and efficient operation of the vehicle network system 100.

Meanwhile, the adaptive platform layer 220 according to an embodiment of the present disclosure may adopt Automotive Open System Architecture (AUTOSAR) standards.

The AUTOSAR standards are global standards that play an essential role in automotive industry and can provide a framework for systematizing and optimizing automotive software and electronic systems. The AUTOSAR standards support efficient development, integration, and repair and maintenance of software during the life cycle of a vehicle and aim to provide standard interfaces and interoperability between software components that run in various ECUs (electronic control units).

One of the major functions of the AUTOSAR standards is the definition and abstraction of standard interfaces. This provides smooth communication between software components and provides interoperability between various ECUs. Also, the AUTOSAR standards can establish a flexible and reusable software architecture by hiding hardware dependency through abstraction and decoupling software from hardware.

Meanwhile, the independence of platforms is another important aspect, and the AUTOSAR standards aim to facilitate software reuse across various platforms. This may improve software portability and help make system upgrades easier. In addition, the AUTOSAR standards support dynamic software updates and extensions and thus provide the flexibility to cope with requirements that vary during the lifecycle of a vehicle.

The key to enabling these functions is a framework that defines a standardized software architecture based on the AUTOSAR standards. Such a framework may support efficient development by maintaining consistency in software development and providing a standardized structure. In addition, this framework may provide vehicle manufacturers and system providers with the flexibility to make adjustments to software according to their needs, by defining structures of and interactions between software components through templates.

Moreover, the AUTSOSAR standards provide a standardized communication stack for in-vehicle communication to help facilitate communication between various ECUs and therefore to improve interactions in distributed systems. Such improvements in interactions may contribute to improving the overall efficiency and performance of vehicles.

According to an embodiment of the present disclosure, the adaptive platform layer 220 may provide a dynamic software architecture for various functions of the vehicle, by adopting an AUTOSAR standard. This may contribute to the ECU 200 in the vehicle network in standardizing and optimizing a software architecture and offers flexibility and efficiency to vehicle manufacturers and system developers.

Next, a vehicle network communication method according to another embodiment of the present disclosure is specifically described.

A vehicle network communication method according to an embodiment of the present disclosure, which controls the statuses of ECUs 200 configured to control the operation of a vehicle 101, may include an event occurrence determination step. In the event occurrence determination step, whether or not a specific event has occurred is determined. The method also includes an MG classification step. In the MG classification step, the ECUs 200 are classified into a first MG, which is needed to perform a specific event, and a second MG, which is not needed to perform the specific event. The method also includes an MG control step in which a signal is transmitted to the first MG and the second MG through a main ECU 201. The method also includes a restoration step in which the ECUs 200 are restored to the original state after the specific event is over. The ECUs 200 configured to control the operation of the vehicle 101 may be classified into a plurality of MGs 110 according to specific functions.

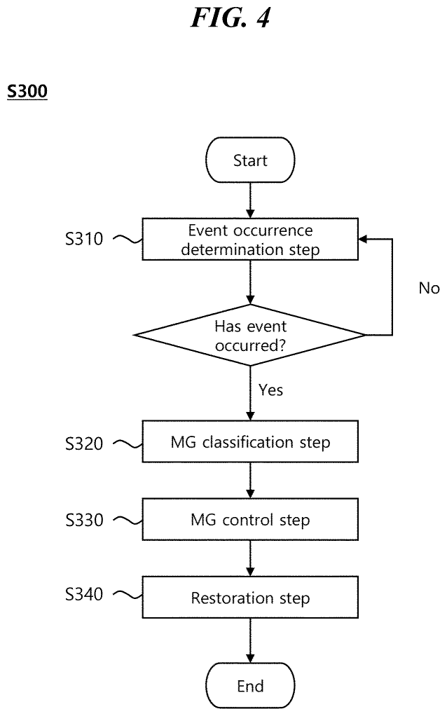

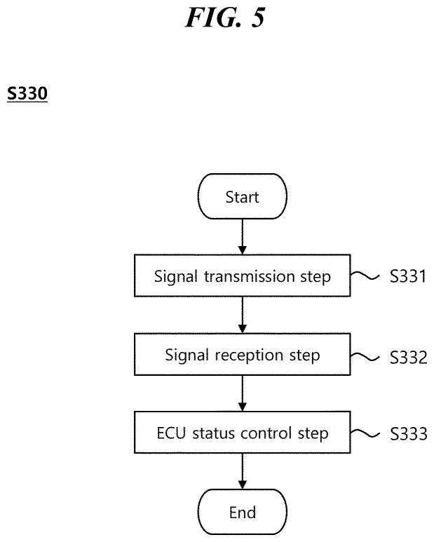

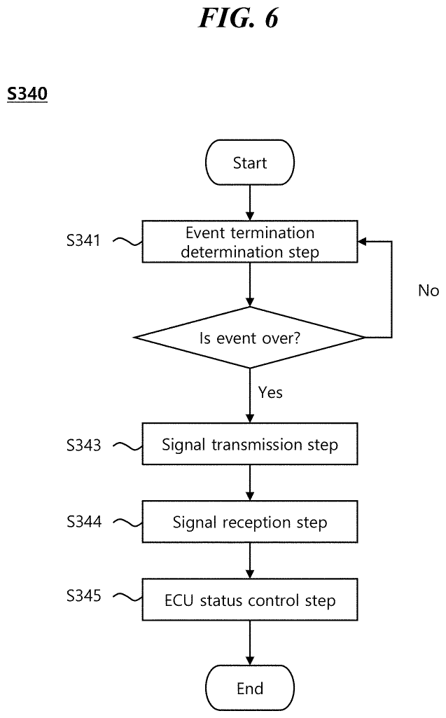

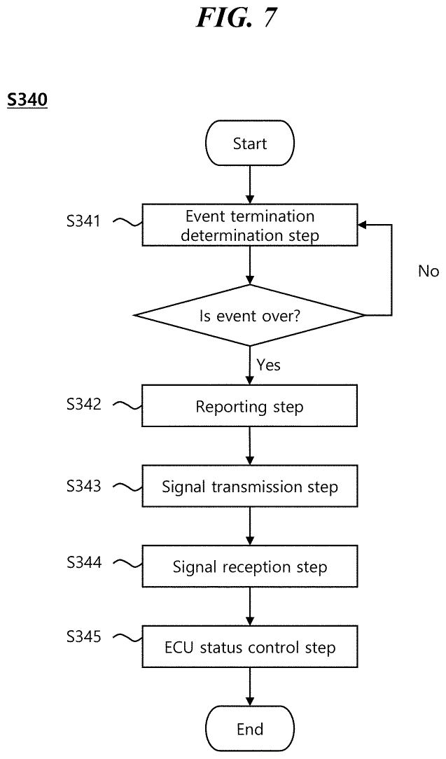

FIG. 4 is a flowchart showing a vehicle network communication method according to an embodiment of the present disclosure. FIG. 5 is a flowchart showing an MG control step according to an embodiment of the present disclosure. FIGS. 6 and 7 are flowcharts showing a restoration step according to an embodiment of the present disclosure.

Referring to FIGS. 4-7, a vehicle network communication method S300 according to an embodiment of the present disclosure may include an event occurrence determination step S310 in which whether or not a specific event has occurred is determined. The vehicle network communication method S300 also includes an MG classification step S320. In the MG classification step S320, the ECUs 200 are classified into a first MG, which is needed to perform a specific event, and a second MG, which is not needed to perform the specific event. The vehicle network communication method S300 also includes an MG control step S330 in which a signal is transmitted to the first MG and the second MG through a main ECU 201. The vehicle network communication method S300 also includes a restoration step S340 in which the ECUs 200 are restored to the original state after the specific event is over.

Specifically, whether or not a specific event has occurred may be determined, and if the specific event has occurred (Yes in S310), the MG classification step S320 may be performed. Otherwise (No in S310), the event occurrence determination step S310 may be repeatedly performed.

In the MG classification step S320, the ECUs 200 may be classified into a first MG, which is needed to perform a specific event, and a second MG, which is not needed to perform the specific event. Thus, a signal sent from the main ECU 201 may be determined.

In the MG control step S330, a signal may be transmitted to the first MG and the second MG through the main ECU 201 to control the operations of these MGs.

In the restoration step S340, when the specific event is over, the vehicle network system 100 may be restored to the state it was in before the occurrence of the specific event.

Meanwhile, one of the MGs 110 includes a main ECU 201 capable of controlling the status of each MG 110 in the vehicle network system 100. The status of each sub-ECU 202 included in an MG 110 whose status is controlled by a signal transmitted from the main ECU 201 may be controlled by the signal transmitted from the main ECU 201.

Moreover, an adaptive platform layer 220 of the ECUs 200 may include an EM 222, which manages the execution and termination of application software programs 211 that run in the ECU 200. The adaptive platform layer 220 of the ECUs 200 may include a CM 221, which supports data communication between the ECUs 200 in the vehicle network.

Specifically, the EM 222 may serve to manage and execute various control functions of a car. The EM 222 may coordinate integration between various systems and hardware in the vehicle in terms of software and may, in particular, provide real-time performance and safety. The EM 222 may improve the safety and performance of vehicle operation by efficiently managing algorithms that are executed in various parts, such as engine control, brake system, electric motor technology, safety functions, etc. Consequently, it is possible to make prompt responses and adjustments to cope with various conditions and situations that occur during driving.

Moreover, the CM 221 may serve to manage communication between various controllers and sensors in the vehicle. Various systems in the vehicle need to be efficiently operated through data exchange and interaction. The CM 221 aims to smoothly coordinate such communication to ensure prompt and stable transmission of data and accurately deliver information generated in real time during driving. Consequently, it is possible to optimize interoperability between systems in the vehicle and accurately deliver information necessary for the driver.

Meanwhile, the EM 222 and the CM 221 may work closely with each other to thereby optimize the overall performance of the vehicle. The EM 222 may provide efficient operation through execution of various algorithms and allow resultant data to be shared with other systems through the CM 221. Consequently, the vehicle 101 is capable of self-optimized operation, such as monitoring current status during driving and taking necessary actions.

An operation mode of the EM 222 may include a primary mode for controlling the status of each MG 110 in the vehicle network system 100 or a secondary mode for operating the EM (EM_S) of each sub-ECU 202 included in an MG 110 whose status is controlled by a signal transmitted from the main ECU 201 including an EM (EM_P), which operates in the primary mode.

Referring to FIG. 3, a plurality of ECUs 201, 202-1, 202-2, and 202-3 may be interconnected and communication through an Ethernet port 233. Here, the ECUs 201, 202-1, 202-2, and 202-3 may be classified into a plurality of MGs 110-1 and 110-2 according to specific functions.

Meanwhile, the EMs 222 included in the adaptive platform layers 220 of the ECUs 200 may include an EM_P 223, which operates in a primary mode for controlling the status of each MG 110 in the vehicle network system 100. The EMs 222 may include EM_Ss 224-1, 224-2, and 224-3, which operate in a secondary mode for operating the EMs 222 of all sub-ECUs 201-1, 202-3, and 202-3 included in the MGs 110-1 and 110-2 whose statuses are controlled by a signal transmitted from the main ECU 201 including the EM_P 223.

However, FIG. 3 is merely an example, and the number of MGs, the number of ECUs, the number of EMs, or the number of Ethernet ports is not limited to what is shown in FIG. 3. Instead, the number of MGs, the number of ECUs, the number of EMs, or the number of Ethernet ports may vary as needed.

Meanwhile, the MG control step S330 may include a signal transmission step S331 in which the EM_P 223 operating in the primary mode in the main ECU 201 transmits a signal to the first MG and the second MG through the CM 221. The MG control step S330 may also include a signal reception step S332 in which the sub-ECUs 202 included in the first MG and the second MG receive the signal. The MG control step S330 may also include an ECU status control step S333 in which the EM_Ss 224 operating in the secondary mode in the sub-ECUs 202, which have received the signal control the status of the corresponding ECU 200.

Specifically, in the signal transmission step S331, separate signals may be transmitted to the first MG, which is not needed to perform a specific event, and may be transmitted to the second MG, which is not needed to perform the specific event.

In the signal reception step S332, the sub-ECUs 202 included in the first MG and the second MG may receive corresponding signals.

In the ECU status control step S333, the EM_Ss 224 operating in the secondary mode in the sub-ECUs 202, which have received the signal, may control the status of the corresponding ECU 200 in accordance with the corresponding signal.

The restoration step S340 may include an event termination determination step S341 in which whether or not the specific event is over is determined. The restoration step S340 may also include a signal transmission step S343 in which the EM_P 223 operating in the primary mode in the main ECU 201 transmits a signal to the first MG and the second MG through the CM 221. The restoration step S340 may also include a signal reception step S344 in which the sub-ECUs 202 included in the first MG and the second MG receive the signal. The restoration step S340 may also include an ECU status control step S345 in which the EM_Ss 224 operating in the secondary mode in the sub-ECUs 202, which have received the signal control the status of the corresponding ECU 200.

Specifically, whether or not the specific event is over may be determined, and if the specific event is over (Yes in S341), the signal transmission step S343 may be performed. Otherwise (No in S341), the event termination determination step S341 may be repeatedly performed.

In the signal transmission step S343, separate signals may be transmitted to the first MG, which has performed the specific event, and may be transmitted to the second MG, which has not performed the specific event.

In the signal reception step S344, the sub-ECUs 202 included in the first MG and the second MG may receive the corresponding signals.

In the ECU status control step S345, the EM_Ss 224 operating in the secondary mode in the sub-ECUs 202, which have received the signal, may control the status of the corresponding ECU 200 in accordance with the corresponding signal.

Meanwhile, the restoration step S340 may further include, after the event termination determination step S341, a reporting step S342. In the reporting step S342, the EM_Ss 224 operating in the secondary mode in the sub-ECUs 202 report to the EM_P 223 operating in the primary mode about whether or not the event is over, so that the EM_P 223 operating in the primary mode in the main ECU 201 checks to see whether or not the event is over. Consequently, it is possible to avoid any collision between the steps and to further improve the reliability of the vehicle network communication method S300.

As a concrete example, a description is made on the assumption that the specific event is a low-power operation of an electric car.

In the event of traffic congestion on a road while the vehicle 101 is driving, there may be a need to operate the electric car at low power. At this time, in the event occurrence determination step S310, it may be determined that an event involving the low-power operation of the electric car has occurred.

Next, in the MG classification step S320, it may be determined that a particular MG's functionality is not required for the next given period of time, and the ECUs 200 may be classified into a first MG, which is needed for low-power operation of the electric car at low power, and a second MG, which is not needed for low-power operation of the electric car.

In the MG control step S330, the EM_P 223 in the main ECU 201 transmits a signal to the first MG and the second MG through the CM 221 (S331), the sub-ECUs 202 included in the first MG and the second MG receive the signal (S332), and the EM_Ss 224 in the first MG, which have received the signal, may transition the status of the corresponding MG from Start up to Shut down.

In the restoration step S340, when there is no need to operate the electric car at low power as the road situation gets better, it is determined that the event is over (S341), the EM_P 223 in the main ECU 201 transmits a signal to the first MG and the second MG through the CM 221, the sub-ECUs 202 included in the first MG and the second MG receive the signal (S344), and the EM_Ss 224 in the first MG, which have received the signal may transition the status of the corresponding MG from Shut down to Start up.

As another concrete example, a description is made on the assumption that the specific event is a real-time partial over-the-air (OTA) update to a navigation system. Here, the OTA refers to the technology that updates vehicle navigation systems and other software. The OTA means making updates over the internet through wireless communication.

As the vehicle 101 is expected to enter a new area while driving, there may arise the need to make a partial update to corresponding regional information in the map. At this time, in the event occurrence determination step S310, it may be determined that an event related to a real-time partial update to the navigation system has occurred.

Next, in the MG classification step S320, the ECUs 200 may be classified into a first MG, which is needed for the partial update to the navigation system, and a second MG, which is not needed for the partial update to the navigation system.

In the MG control step S330, the EM_P 223 in the main ECU 201 transmits a signal to the first MG and the second MG through the CM 221 (S331), the sub-ECUs 202 included in the first MG and the second MG receive the signal (S332), and the EM_Ss 224 in the first MG, which have received the signal, may transition the status of the corresponding MG from Start up to Update.

In the restoration step S340, upon completion of the update, it is determined that the event is over (S341), the EM_Ss 224 of the sub-ECUs 202 included in the first MG may report to the EM_P 223 through the CM 221 about the completion of the partial update to the navigation system (S342), the EM_P 223 in the main ECU 201 may transmit a signal to the first MG and the second MG through the CM 221 (S343), the sub-ECUs 202 included in the first MG and the second MG may receive the signal (S344), and the EM_Ss 224 in the first MG group, which have received the signal, may transition the status of the corresponding MG from Update to Start up.

The foregoing concrete description is given to help understanding of the present disclosure. However, the foregoing detailed descriptions merely illustrate one example of the content and effects of the present disclosure and therefore shall not be construed as limiting the scope and effects of the present disclosure.

Meanwhile, according to another embodiment of the present disclosure, a computer-readable recording medium has a program recorded thereon to perform the vehicle network communication method S300.

Next, a vehicle network apparatus according to yet another embodiment of the present disclosure, which controls the statuses of ECUs 200 configured to control the operation of a vehicle, may include a plurality of MGs 100 into which the ECUs 200 are classified according to specific functions. One of the MGs 110 may include a main ECU 201 capable of controlling the status of each MG 110 in the vehicle network apparatus. The status of each sub-ECU 202 included in an MG 110 whose status is controlled by a signal transmitted from the main ECU 201 may be controlled by the signal transmitted from the main ECU 201. An adaptive platform layer 220 included in the ECU 200 may include an EM 222, which manages the execution and termination of application software programs 211 that run in the ECU 200, and may include a CM 221, which supports data communication between the ECUs 200 in the vehicle network.

Specifically, the EM 222 may serve to manage and execute various control functions of a car. The EM 222 may coordinate integration between various systems and hardware in the vehicle in terms of software and may, in particular, provide real-time performance and safety. The EM 222 may improve the safety and performance of vehicle operation by efficiently managing algorithms that are executed in various parts, such as engine control, brake system, electric motor technology, safety functions, etc. Consequently, it is possible to make prompt responses and adjustments to cope with various conditions and situations that occur during driving.

Moreover, the CM 221 may serve to manage communication between various controllers and sensors in the vehicle. Various systems in the vehicle need to be efficiently operated through data exchange and interaction. The CM 221 aims to smoothly coordinate such communication to ensure prompt and stable transmission of data and accurately deliver information generated in real time during driving. Consequently, it is possible to optimize interoperability between systems in the vehicle and accurately deliver information necessary for the driver.

Meanwhile, the EM 222 and the CM 221 may work closely with each other to thereby optimize the overall performance of the vehicle. The EM 222 may provide efficient operation through execution of various algorithms and may allow resultant data to be shared with other systems through the CM 221. Consequently, the vehicle 101 is capable of self-optimized operation, such as monitoring current status during driving and taking necessary actions.

An operation mode of the EM 222 may include a primary mode for controlling the status of each MG 110 in the vehicle network apparatus or a secondary mode for operating the EM (EM_S) of each sub-ECU 202 included in an MG 110 whose status is controlled by a signal transmitted from the main ECU 201 including an EM (EM_P), which operates in the primary mode.

Referring to FIG. 3, a plurality of ECUs 201, 202-1, 202-2, and 202-3 may be interconnected and communicate through an Ethernet port 233. Here, the ECUs 201, 202-1, 202-2, and 202-3 may be classified into a plurality of MGs 110-1 and 110-2 according to specific functions.

Meanwhile, the EMs 222 included in the adaptive platform layers 220 of the ECUs 200 may include an EM_P 223, which operates in a primary mode for controlling the status of each MG 110 in the vehicle network apparatus. The EMs 222 may also include EM_Ss 224-1, 224-2, and 224-3, which operate in a secondary mode for operating the EMs 222 of all sub-ECUs 201-1, 202-3, and 202-3 included in the MGs 110-1 and 110-2 whose statuses are controlled by a signal transmitted from the main ECU 201 including the EM_P 223.

However, FIG. 3 is merely an example, and the number of MGs, the number of ECUs, the number of EMs, or the number of Ethernet ports is not limited to what is shown in FIG. 3. Instead, the number of MGs, the number of ECUs, the number of EMs, or the number of Ethernet ports may vary as needed.

Terms, such as “include”, “consist of”, or “have” described above, mean that the corresponding component may be present unless otherwise stated. Thus, the terms should be construed that the terms do not exclude other components but may further include other components. All terms, including technical or scientific terms, have the same meaning as commonly understood by those having ordinary skill in the art to which the present disclosure belongs, unless defined otherwise. Generally used terms, such as terms defined in the dictionary, should be interpreted as being consistent with the contextual meaning of the related art and should not be interpreted in an ideal or excessively formal meaning unless explicitly defined in the present disclosure.

The above descriptions merely illustrate the technical idea of the present disclosure. Those having ordinary skill in the art to which the present disclosure belongs may perform various modification and changes within the scope and without departing from the essential characteristics of the present disclosure. Accordingly, the embodiments disclosed in the present disclosure are not intended to limit but to explain the technical idea of the present disclosure. The scope of the technical spirit of the present disclosure is not limited by these embodiments. The scope of protection of the present disclosure should be interpreted by the claims below, and all technical spirits within the scope equivalent to the scope of the claims should be interpreted as being included in the scope of the claims of the present disclosure.

What is claimed is:

1. A vehicle network system for controlling statuses of electronic control units (ECUs) configured to control an operation of a vehicle, the vehicle network system comprising:
a plurality of machine groups (MGs),
wherein the ECUs are classified into the plurality of MGs according to specific functions, and
wherein one of the MGs includes a main electronic control unit (ECU) configured to control the status of each machine group (MG) in the vehicle network system.

2. The vehicle network system of claim 1, wherein the ECUs are configured to communicate with one another by using at least one communication protocol of Controller Area Network (CAN), Local Interconnect Network (LIN), FlexRay, or Media Oriented Systems Transport (MOST).

3. The vehicle network system of claim 1, wherein the ECUs include at least one of an engine control unit, a brake control module, a steering control module, an airbag control module, an electronic control suspension, a transmission control module, an infotainment and information control unit, an advanced driver assistance systems control module, a collision avoidance and prevention systems control module, or an autonomous driving control module.

4. The vehicle network system of claim 1, wherein a status of each sub-ECU included in an MG having a status controlled by a signal transmitted from the main ECU is controlled by the signal.

5. The vehicle network system of claim 1, wherein the ECUs include an application layer including a plurality of application software programs, a hardware layer including hardware components, and an adaptive platform layer for interaction between the application layer and the hardware layer.

6. The vehicle network system of claim 5, wherein the application layer includes a plurality of functional groups (FGs), and
wherein the plurality of application software programs is classified into the plurality of FGs according to specific functions.

7. The vehicle network system of claim 5, wherein the hardware layer includes an Ethernet port for network communication of the ECU.

8. The vehicle network system of claim 5, wherein the adaptive platform layer includes:
an execution management (EM) configured to manage execution and termination of application software programs that run in the ECU; and
a communication management (CM) configured to support data communication between the ECUs in the vehicle network system.

9. The vehicle network system of claim 8, wherein an operation mode of the EM includes:
a primary mode configured to control the status of each MG in the vehicle network system; or
a secondary mode configured to operate the EM (EM_S) of each sub-ECU included in an MG having a status controlled by a signal transmitted from the main ECU including an EM (EM_P) operating in the primary mode.

10. The vehicle network system of claim 9, wherein there is only one EM (EM_P) present within the vehicle network system that operates in the primary mode.

11. A vehicle network communication method for controlling statuses of ECUs configured to control an operation of a vehicle, the vehicle network communication method comprising:
in an event occurrence determination step, determining whether or not a specific event has occurred;
in an MG classification step, classifying the ECUs into a first MG, which is needed to perform a specific event, and a second MG, which is not needed to perform the specific event;
in an MG control step, transmitting a signal to the first MG and the second MG through a main ECU; and
in a restoration step, restoring the ECUs to an original state after the specific event is over,
wherein the ECUs configured to control the operation of the vehicle are classified into a plurality of MGs according to specific functions.

12. The vehicle network communication method of claim 11, further comprising:
controlling a status of each sub-ECU included in an MG by a signal,
wherein a status of the MG is controlled by the signal transmitted from the main ECU.

13. The vehicle network communication method of claim 11, further comprising:
managing, by an EM of an adaptive platform layer of the ECUs, execution and termination of application software programs that run in the ECU; and
supporting, by a CM of the adaptive platform layer of the ECUs, data communication between the ECUs in a vehicle network system.

14. The vehicle network communication method of claim 13, further comprising:
in a primary mode of the EM, controlling the status of each MG in a vehicle network system; or
in a secondary mode of the EM, operating the EM (EM_S) of each sub-ECU included in an MG having a status controlled by a signal transmitted from the main ECU including an EM (EM_P) operating in the primary mode.

15. The vehicle network communication method of claim 14, wherein the MG control step includes:
in a signal transmission step, transmitting, by the EM (EM_P) operating in the primary mode in the main ECU, a signal to the first MG and the second MG through the CM;
in a signal reception step, receiving, by the sub-ECUs included in the first MG and the second MG, the signal; and
in an ECU status control step, controlling, by the EMs (EM_Ss) operating in the secondary mode in the sub-ECUs and having received the signal, the status of the corresponding ECU.

16. The vehicle network communication method of claim 14, wherein the restoration step includes:
in an event termination determination step, determining whether or not the specific event is over;
in a signal transmission step, transmitting, by the EM (EM_P) operating in the primary mode in the main ECU, a signal to the first MG and the second MG through the CM;
in a signal reception step, receiving, by the sub-ECUs included in the first MG and the second MG, the signal; and
in an ECU status control step, controlling, by the EMs (EM_Ss) operating in the secondary mode in the sub-ECUs and having received the signal, the status of the corresponding ECU.

17. The vehicle network communication method of claim 14, wherein the restoration step further includes:
after an event termination determination step, in a reporting step, reporting, by the EMs (EM_Ss) operating in the secondary mode in the sub-ECUs, to the EM (EM_P) operating in the primary mode about whether or not the event is over, so that the EM (EM_P) operating in the primary mode in the main ECU checks to see whether or not the event is over.

18. A computer-readable storage medium having a program recorded thereon to perform the vehicle network communication method of claim 11.

19. A vehicle network apparatus for controlling statuses of ECUs configured to control an operation of a vehicle, the vehicle network apparatus comprising:
a plurality of MGs,
wherein the ECUs are classified into the plurality of MGs according to specific functions,
wherein one of the MGs includes a main ECU configured to control the status of each MG in the vehicle network apparatus,
wherein a status of each sub-ECU included in an MG having a status controlled by a signal transmitted from the main ECU is controlled by the signal, and
wherein an adaptive platform layer included in the ECUs includes:
an EM configured to manage execution and termination of application software programs that run in the ECU; and
a CM configured to support data communication between the ECUs in the vehicle network apparatus.

20. The vehicle network apparatus of claim 19, wherein an operation mode of the EM includes:
a primary mode configured to control the status of each MG in the vehicle network apparatus; or
a secondary mode configured to operate the EM (EM_S) of each sub-ECU included in an MG having a status controlled by a signal transmitted from the main ECU including an EM (EM_P) operating in the primary mode.
